(19) United States
(12) Patent Application Publication
(10) Pub. No.: US 2007/0024456 A1
(43) Pub. Date: Feb. 1, 2007

(54) Illuminating temperature indicator

(76) Inventor: Joseph Edward Currie, Webster, NH (US)

Correspondence Address: JOSEPH E. CURRIE, 506 WHITE PLAINS RD., WEBSTER, NH, 03303-7112, US

(21) Appl. No.: 11/441,684

(22) Filed: May 26, 2006

Related U.S. Application Data
(60) Provisional application No. 60/702,238, filed on Jul. 26, 2005.

(51) Int. Cl. G08B 17/00

(52) U.S. Cl. 340/584

(57) ABSTRACT

An illuminating acrylic temperature-indicating device that provides for a visual temperature indication of a fluid within a conduit, or a storage tank. The acrylic indicator mixes and blends the illumination from imbedded blue LEDs and red LEDs and separate electronic control circuits control each color of LEDs with separate temperature sensing thermistors. The indicator glows with blue, shades of magenta, and red colors as the temperature of a monitored liquid changes from cold to hot. The individual control circuits that control the illumination modulation intensity of the red and blue LEDs each provide a user with a manual adjustment that allows a user to set the hot and cold temperature sensing parameters of the device. The acrylic indicator illuminates with enough light intensity to be visible under all normal lighting conditions and is intended to operate continuously.

### CROSS REFERENCE TO RELATED APPLICATIONS

Please refer to Provisional application No. 60/702,238, filing date Jul. 26, 2005.

### STATEMENT REGARDING FEDERALLY SPONSORED RESEARCH OR DEVELOPMENT

(Not Applicable)

### BACKGROUND OF THE INVENTION

Heated oil pipe lines inspected from the air by helicopter or stol type pipeline patrol aircraft presently are inspected for leaks or structural damage, but there does not presently exist a way for patrol aircraft to determine if the oil temperature within the pipeline is correct, and if not correct at what location along the pipeline the temperature decreases. One embodiment of the present invention places illuminating liquid temperature indicators on above ground pipelines that are visible from the air or ground.

In another embodiment of the present invention a user of a tap or other fluid outlet is warned of hot liquid. Scalding hot liquid from a tap or other liquid outlet often warns the user by emanating visible vapor, however liquids of 160 degrees Fahrenheit or hotter do not always warn of hot temperature with vapor. The appearance of most liquids flowing from a tap, faucet, or other outlet does nothing to alert the user as to the temperature of the liquid. While there may be some vapor emanating from some hot fluids, this is not always the case, and it can be difficult to determine the temperature of a flowing liquid without touching the liquid flow. Moreover, it often takes some time, (perhaps a minute or so), for a hot liquid to arrive at a tap or outlet once the hot liquid tap or outlet has been turned on. A person actuating such a tap or outlet has no way of knowing just when the hot liquid actually begins to flow from the tap or outlet, especially if the hot liquid supply is some distance away.

The need arises for a device that automatically provides an indication of the temperature of a fluid flowing from a tap or other outlet. Rather than operating a dial or other indicator, that may be difficult for some people to understand, the device must provide an unambiguous color indication of the fluid temperature, be bright enough to be seen in all normal lighting conditions, and be illuminated continuously, not requiring any associated switching device. Moreover, the

device may be mounted on a wail, pipe, or tank, or as a base plate upon which a faucet is mounted, or as a part of a faucet or shower installation.

U.S. Pat. No. 3,450,159 issued to Ira E. Wilkin on Jun. 17, 1969 discloses a Control Box Water Faucet in which push button controls are used to momentarily or continuously actuate solenoids controlling the flow of cold or hot water from a faucet. The device also includes two indicator lights, one for hot and one for cold water flows. However, the lights provide only an indication that the appropriate solenoid is actuated, and do nothing to provide an actual indication of the temperature of the water flow emanating from the faucet. Moreover, the lights are in the same location as the control buttons, somewhat removed from the output and of the faucet.

U.S. Pat. No. 3,960,016 issued to Paul C. Symmons on Jun. 1, 1976 discloses a Water Mixing Valve with Temperature Indicator. The device comprises a standard mixing valve, as used in bathroom shower water supplies and the like, including a bimetallic temperature indicator. No color coding or liquid illumination means is disclosed.

U.S. Pat. No. 4,749,126 issued to H. P. M. Kessener, ET. Al. on Jun. 7, 1988 discloses an illuminated stream or flow of water with illumination operated by a flow switch 60 that is intrusive with respect to the conduit.

U.S. Pat. No. 4,978,833 issued to John T. Knepler on Dec. 18, 1990 discloses a Hot Water Dispenser Having Improved Water Temperature Control System. The only illumination means disclosed is in the form of an LED type “ready” light, as is well known in such devices as electric coffee urns and the like.

U.S. Pat. No. 5,019,690 issued to John T. Knepler on May 28, 1991 discloses a Boiling Water Dispenser Having Improved Water Temperature Control System. The illuminated indicator means is essentially identical to that of the same inventor's U.S. Pat. No. 4,978,833 discussed above.

U.S. Pat. No. 5,095,941 issued to John J. Betz on Mar. 17, 1992 discloses a Method and Apparatus for Actuating a Faucet. Hot and cold indicator lights are disclosed, but these two lights are nothing more than indicators of the position of an electrical switch that is used to select the water temperature desired. Thus, they do not indicate water temperature, but rather the position of the selector switch.

U.S. Pat. No. 5,125,433 issued to Charles F. DeMoss at al. on Jun. 30, 1992 discloses a System for Electronically Controlling the Temperature OF Water Delivered to a Bath, Shower or the Like. No lighted temperature indicator means is disclosed.

U.S. Pat. No. 5,491,617 issued to Joseph E. Currie on Feb. 13, 1996 discloses an illumination device that illuminates a tap handle and an area proximate to a tap outlet. Said device communicates remote lamp illumination to said tap handle and to the tap outlet by separate fiber optic cables.

U.S. Pat. No. 6,805,458 issued to James T. Petroski et al. on Oct. 19, 2004 discloses a night light as part of a plumbing fixture comprised of two LED colors that are responsive to the water temperature disposed on or in a plumbing fixture for directly illuminating at least one of the handle, the water flow, and an associated basin.

None of the above noted patents describes a light transmissive acrylic piece that can be mounted in any location proximate a fluid conduit, storage tank, or plumbing fixture, that is continuously brightly illuminated from within, and that mixes the illumination from a red and a blue LED arrangement to create shades of a magenta color as the fluid temperature in a fluid conduit, storage tank, or plumbing fixture changes from either cold to hot, or hot to cold, as does the present invention.

None of the above noted patents, taken either singly or in combination, are seen to disclose the specific arrangement of concepts or claimed features disclosed by the present invention.

### SUMMARY OF THE INVENTION

By the present invention, an improved fluid temperature-monitoring device is disclosed.

Accordingly, one of the objects of the present invention is to provide an improved fluid temperature-monitoring device that is always brightly illuminated with a color indicative of the temperature of a fluid within a conduit, storage vessel, or plumbing fixture.

Another object of the present invention is to provide an illuminated indicator of a fluid temperature, where the indicator may be mounted proximate the liquid containing vessel or mounted remote from the liquid container.

Another object of the present invention is that all four components of the present invention, the illuminated liquid temperature indicator, the temperature sensing thermistors, the dual LED control circuits, and the power supply, may be combined into a package and mounted as a unit, or that all four of the components of the illuminated liquid temperature indicator may be mounted in separate locations.

A further objective of the present invention is to provide an improved fluid illumination device that, in an alternative embodiment, may be made completely portable and that is disposed completely outside of any fluid conduit, pipe, or storage tank.

A final object of the present invention is to provide an improved fluid illumination device for the purposes described that is inexpensive, dependable and fully effective in accomplishing its intended purposes.

These and other objects will appear as the nature of the invention is better understood. The invention consists in the novel combination and arrangement of parts hereinafter more fully describes, illustrated, and claimed, with references being made to the attached drawings.

### BRIEF DESCRIPTION OF THE DRAWINGS

FIG. 1 is an oblique bottom view of the acrylic indicator with imbedded LEDs, and a schematic of the control circuits for the LEDs with associated power supply.

FIG. 2A is a block diagram showing one arrangement of the electrical components of the invention mounted in different locations.

FIG. 2B is a view of the installation of the acrylic indicator of the present invention installed on the side of a storage tank with an associated solar cell power supply, and with control circuits mounted either as part of the indicator or power supply.

FIG. 3A is a view of the acrylic indicator installed on the side of a pipeline with a power unit that is electrically connected to a power grid.

FIG. 3B is a view of the acrylic indicator installed on the side of a pipeline powered by a solar power supply.

### DETAILED DESCRIPTION OF THE PREFERRED EMBODIMENTS

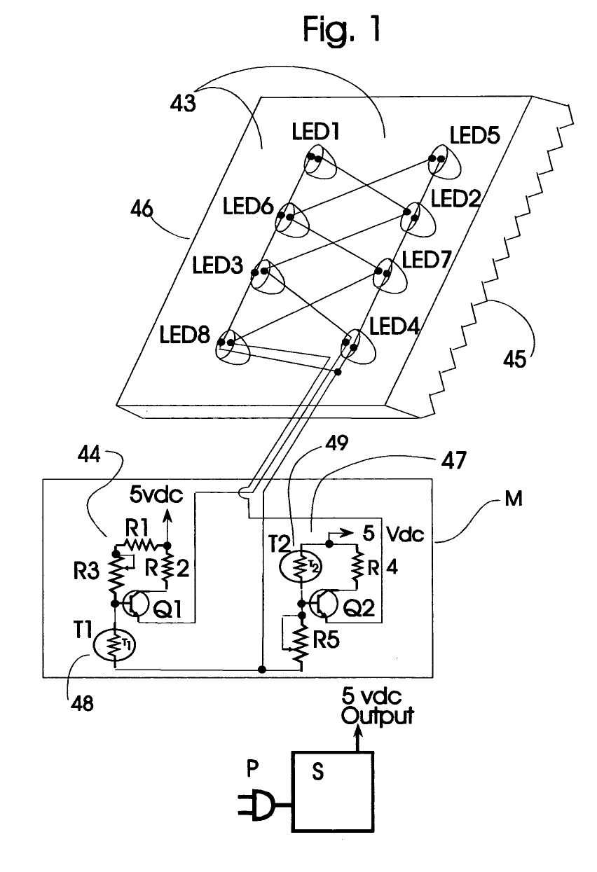

Referring now particularly to FIG. 1 of the drawings, the present invention will be seen to relate to a device providing for the automatic illumination of acrylic indicator 46, with triangular grooves 45, and light reflective surface 43, that displays a color indicating the temperature of a fluid that is within a conduit or container, and the apparatus comprising the device. Two electronic control circuits 44 and 47 of the present invention are mounted in control box M, or in the base of indicator 46, or in associated power supply unit S. Control circuit 44 modulates the voltage to red LEDs 1 through 4, and control circuit 47 modulates the voltage to blue LEDs 5 through 8, so that the illumination mixing and blending qualities of acrylic indicator 46 provide a continuous change of color of acrylic indicator 46 as the temperature of a monitored liquid changes.

The color of acrylic indicator 46 will vary from blue, through shades of magenta, to red, as the temperature of the monitored liquid changes from cold to hot and from red, through shades of magenta to blue, as the monitored temperature changes from hot to cold.

Control box M and power supply S may be mounted remote from acrylic indicator 46.

Power supply S may receive electrical power by means of any conveniently located standard 115-vac or 220-vac power outlet. The ac electrical power is transformed to 5 vdc for the operation of the various components of the present invention by means of a standard switching power supply circuit within control box S.

The device of the present invention is actuated whenever electrical power is supplied to control circuits 44 and 47.

The present invention preferably utilizes a non-intrusive means of detecting the temperature of a fluid by mounting thermistors 48 and 49 against an external side of a fluid conduit or container and enhancing heat or cold conduction from the liquid within said conduit or container to thermistors 48 and 49 by application of a heat sink compound between said container and thermistors 48 and 49. The metal of a fluid conduit or container will rapidly take on the temperature of a fluid therein, thus the thermistor temperature sensors 48 and 49 provide practically instantaneous information to the temperature sensing circuits 44 and 47 of the present invention.

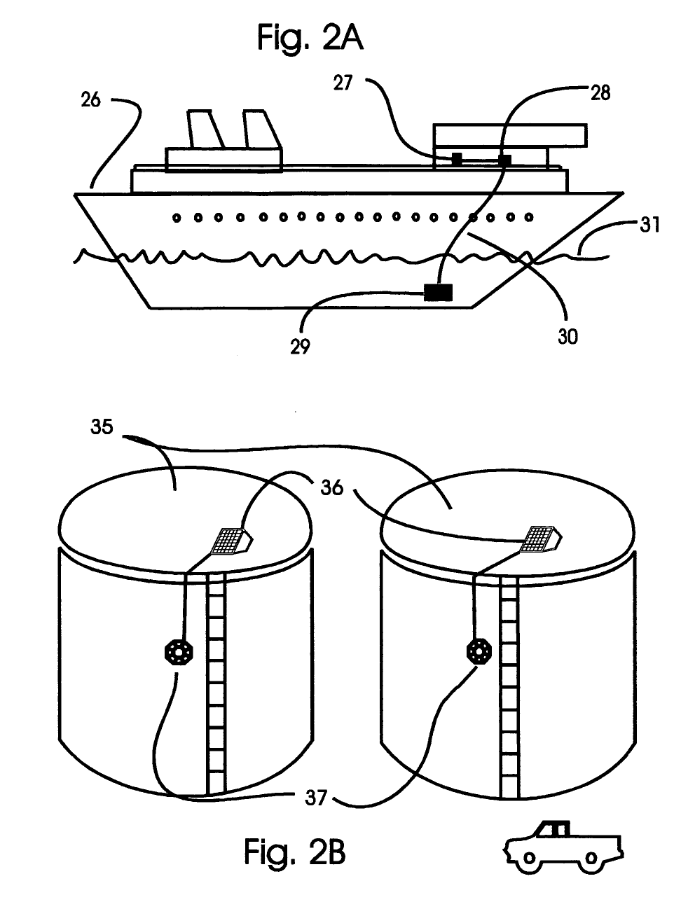

FIG. 2A is a block diagram of a ship or other water vessel 26 depicting the components of the present invention mounted in locations remote from each other. The illuminating liquid temperature indicator 27 is mounted with other ships indicators remote from power supply 28. Temperature sensing thermistors 29 communicates with control circuits 28 through electrical signal cable 30 and the thermistors 29 are mounted against the inside of the ships metal hull well below the outside water line 31.

FIG. 2B depicts two illuminating liquid temperature indicators 37 mounted on the outside of storage tanks 35 with remote mounted solar panel power and control units 36.

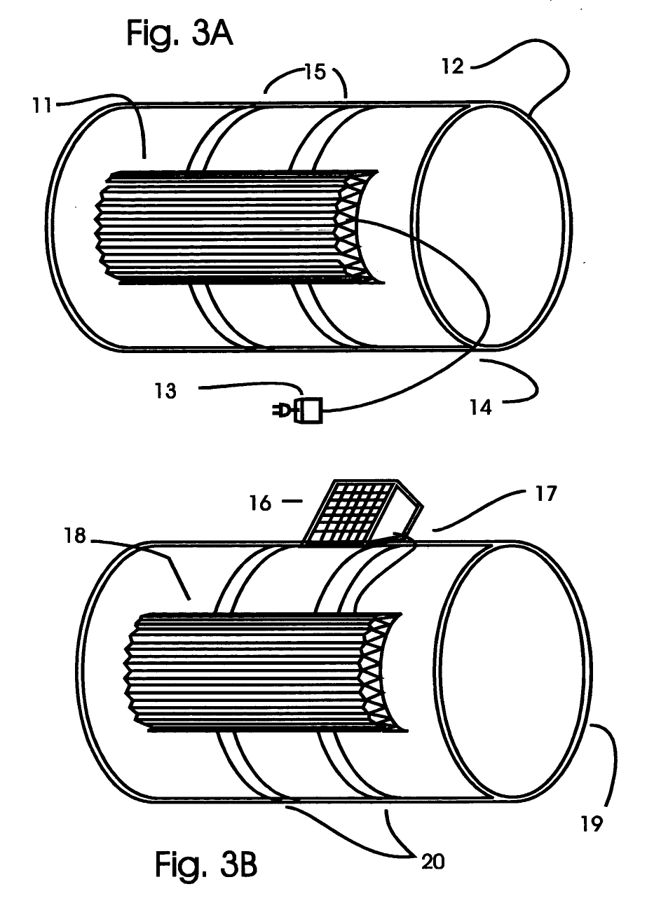

FIG. 3A illustrates an illuminating liquid temperature indicator 11 mounted to pipeline 12 with mounting straps 15 and connected to power and control unit 13 by electrical signal cable 14.

FIG. 3B depicts illuminating liquid temperature indicator 18 secured to pipeline 19 with mounting straps 20 and electrically connected to combination solar panel power supply and control circuits 16 by cable 17.

What is claimed is:

1. An illuminating temperature indicator to visually monitor the temperature of a liquid or a gas within a conduit or a container comprising:
a light transmissive acrylic piece with two or more blue light emitting diodes disposed within the base side of the acrylic piece, and two or more red light emitting diodes disposed within the same base side of the acrylic piece, and a light reflective surface on or against at least a base side of the acrylic piece, and surface facets on at least a top side of the acrylic piece,
and the light transmissive acrylic piece serving as a mixing and blending device that combines the illumination from the independently and separately controlled blue and red light emitting diodes creating shades of magenta illumination,
a first control circuit for control of the intensity modulation of the blue light emitting diodes and a second control circuit for controlling the intensity modulation of the red light emitting diodes,
a first control circuit temperature sensing thermistor and a second control circuit temperature sensing thermistor,
the first control circuit modulating the illumination intensity of the blue light emitting diodes upon detection of, and the temperature of a cold liquid or gas, and the second control circuit modulating the illumination intensity of the red light emitting diodes upon detection of, and the temperature of a hot liquid or gas,
a power supply common to both the first and second control circuits.

2. The illuminating temperature indicator as set forth in claim 1, wherein a first control circuit is adjusted to modulate the illumination intensity of two or more blue light emitting diodes to full brilliance when cold liquid or gas is detected by the first control circuit, and to decrease the blue light intensity of the light emitting diodes in a generally linear manner to zero illumination emitted as the temperature of the monitored liquid or gas increases through warm to hot.

3. The illuminating temperature indicator as set forth in claim 1, wherein a second control circuit is adjusted to modulate the illumination intensity of two or more red light emitting diodes to full brilliance when hot liquid or gas is detected by said second control circuit, and to decrease the red light intensity of the red light emitting diodes in a generally linear manner to zero illumination emitted as the temperature of the monitored liquid or gas decreases through warm to cold.

4. The illuminating temperature indicator as set forth in claim 1, wherein the conduit or container is any pipe for movement of any liquid or gas, or a petroleum or natural gas pipeline, or a water pipe or fixture, or a motor vehicle tank truck or railroad tank car, or any tank for storage of a liquid or gas.

5. The illuminating temperature indicator as set forth in claim 1, wherein the first and second control circuits each provide an accessible manual adjustment that allows the user to electrically calibrate the modulation intensity of the blue and red illumination provided to the light transmissive illumination mixing acrylic indicator.

6. The illuminating temperature indicator as set forth in claim 1, wherein the reflective surface on or against at least a base side of the acrylic piece is smooth, granular, striated, segmented, or faceted.

7. The illuminating temperature indicator as set forth in claim 1, wherein the surface facets are triangular shaped grooves, or other shapes with surfaces that reflect light from the internally mounted diodes back into the acrylic piece.

8. The illuminating temperature indicator as set forth in claim 1, wherein the power supply unit transforms both 60 Hz 115 vac, and 50 Hz 220 vac to five volts dc.

9. The illuminating temperature indicator as set forth in claim 1, wherein the first and second control circuits are electrically powered by a solar cell power supply.

10. The illuminating temperature indicator as set forth in claim 1, wherein all four of the component parts, the light transmissive acrylic mixing piece, the first and second control circuits, the first and second temperature sensing thermistors, and the power supply are remotely located one from another, or mounted and affixed apart.

11. The illuminating temperature indicator as set forth in claim 1, wherein all four of the component parts, the light transmissive acrylic mixing piece, the first and second control circuits, the first and second temperature sensing thermistors, and the power supply are collocated in any combination.

12. The illuminating temperature indicator as set forth in claim 1, wherein light emitting red and blue diodes are mounted in close proximity to at least a first light transmissive surface of a light transmissive acrylic illumination mixing piece to direct red and blue light into the acrylic piece and the light emitting diodes are mounted in an alternating geometric or circular pattern.
